(19) United States
(12) Patent Application Publication
(10) Pub. No.: US 2026/0040129 A1
(43) Pub. Date: Feb. 5, 2026

(54) DETECTION OF UNEXPECTED SENSING MEASUREMENTS IN A WIRELESS COMMUNICATIONS SYSTEM

(71) Applicant: Lenovo (United States) Inc., Morrisville, NC (US)

(72) Inventors: Andreas KUNZ, Ladenburg (DE); Sheeba Backia Mary BASKARAN, Friedrichsdorf (DE); Seyedomid TAGHIZADEH MOTLAGH, Oberursel (DE); Genadi VELEV, Darmstadt (DE); Robin Rajan THOMAS, Bad Nauheim (DE)

(21) Appl. No.: 19/355,909

(22) Filed: Oct. 10, 2025

(51) Int. Cl. H04W 24/10; G01S 7/00; G01S 7/41; G01S 13/86

(52) U.S. Cl. CPC H04W 24/10; G01S 7/006; G01S 7/411; G01S 7/415; G01S 13/86

(57) ABSTRACT

Various aspects of the present disclosure relate to sensing operations and associated sensing procedures that avoid or mitigate issues associated with detections of target objects, such as erroneous detections of a targeted object due to obstacles within a target sensing area. In some cases, a sensing function may be configured to perform checks or verifications on received sensing measurement results and adjust running sensing operations based on the performed checks or verifications. For example, the sensing function may determine whether a sensing measurement result is an expected measurement result (e.g., includes parameters expected within various measurements), and perform actions based on whether the sensing measurement results matches the expected measurement results.

### TECHNICAL FIELD

The present disclosure relates to wireless communications, and more specifically to detecting unexpected (e.g., incorrect, erroneous, or ambiguous) sensing measurements.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for performing sensing operations, including sensing operations that incorporate or implement the detection of unexpected sensing results and/or adjustments of sensing procedures based on sensing results.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit a sensing measurement request to a sensing entity, receive, in response to the sensing measurement request, a sensing measurement result from the sensing entity, determine whether the sensing measurement result comprises an expected measurement result, and perform an action based on the determination.

A method performed or performable by the network entity is described. The method may comprise transmitting a sensing measurement request to a sensing entity, receiving, in response to the sensing measurement request, a sensing measurement result from the sensing entity, determining whether the sensing measurement result comprises an expected measurement result, and performing an action based on the determination.

In some implementations of the network entity and method described herein, to determine whether the sensing measurement result comprises an expected measurement result, the network entity and method may further be configured to, capable of, performed, performable, or operable to identify a mismatch between one or more parameters of the sensing measurement result and one or more parameters of the expected measurement result.

In some implementations of the network entity and method described herein, the one or more parameters of the sensing measurement result and the expected measurement result include at least one parameter for movement of a target object associated with the sensing measurement result.

In some implementations of the network entity and method described herein, the one or more parameters of the sensing measurement result and the expected measurement result include at least one parameter for a size or location of a target object associated with the sensing measurement result.

In some implementations of the network entity and method described herein, the sensing measurement result is an unexpected measurement result, and the network entity and method may further be configured to, capable of, performed, performable, or operable to adjust one or more parameters of a subsequent sensing measurement request and transmit the subsequent sensing measurement request to a different sensing entity.

In some implementations of the network entity and method described herein, the adjusted one or more parameters include an identification of a sensing area within which to perform a sensing measurement.

In some implementations of the network entity and method described herein, the adjusted one or more parameters are associated with a subset of measurements that caused the unexpected measurement result.

In some implementations of the network entity and method described herein, the sensing measurement result is an unexpected measurement result, and the network entity and method may further be configured to, capable of, performed, performable, or operable to adjust one or more parameters of a subsequent sensing measurement request and transmit the subsequent sensing measurement request to a transmission and reception point (TRP) of the sensing entity that is different than an initial TRP that performed a sensing measurement indicated in the sensing measurement result.

In some implementations of the network entity and method described herein, the sensing measurement result includes an identification of the initial TRP that performed the sensing measurement.

In some implementations of the network entity and method described herein, the network entity and method may further be configured to, capable of, performed, performable, or operable to receive, from a network function, a sensing request having one or more parameters, including: an identifier of a target sensing area, an identifier of a target object, or a sensing service type for a sensing measurement and select the sensing entity based on the one or more parameters of the sensing request.

In some implementations of the network entity and method described herein, the sensing measurement result is an unexpected measurement result, and the network entity and method may further be configured to, capable of, performed, performable, or operable to transmit a subsequent sensing measurement request, receive a subsequent sensing measurement result, compare the subsequent sensing measurement result with the sensing measurement result and the expected measurement result, and determine a sensing information result based on the comparison.

In some implementations of the network entity and method described herein, the network entity and method may further be configured to, capable of, performed, performable, or operable to transmit, to the network function, a sensing response message that includes the sensing information result.

A network entity for wireless communication is described. The network entity may be configured to, capable of, or operable to perform one or more operations as described herein. For example, the network entity may comprise at least one memory and at least one processor coupled with the at least one memory and configured to cause the network entity to receive a sensing measurement result from a first sensing entity, determine whether the sensing measurement result comprises an expected measurement result, and generate a sensing information result based on the determination.

A method performed or performable by the network entity is described. The method may comprise receiving a sensing measurement result from a first sensing entity, determining whether the sensing measurement result comprises an expected measurement result, and generating a sensing information result based on the determination.

In some implementations of the network entity and method described herein, the sensing measurement result is not an expected measurement result, and the network entity and method may further be configured to, capable of, performed, performable, or operable to transmit a sensing measurement request to a second sensing entity, receive a subsequent sensing measurement result from the second sensing entity, compare the subsequent sensing measurement result with the expected measurement result, and when the subsequent sensing measurement result matches the expected measurement result generating the sensing information result using the subsequent sensing measurement result.

In some implementations of the network entity and method described herein, the sensing measurement result is not an expected measurement result, and the network entity and method may further be configured to, capable of, performed, performable, or operable to transmit a sensing measurement request to a second sensing entity, receive a subsequent sensing measurement result from the second sensing entity, compare the subsequent sensing measurement result with the expected measurement result, and when the subsequent sensing measurement result does not match the expected measurement result, generate the sensing information result using the sensing information result and subsequent sensing measurement result.

In some implementations of the network entity and method described herein, the sensing measurement result is not an expected measurement result, and the network entity and method may further be configured to, capable of, performed, performable, or operable to transmit a sensing measurement request to a second sensing entity, wherein the first sensing entity is a first base station and the second sensing entity is a second base station different from the first base station.

In some implementations of the network entity and method described herein, the sensing measurement result is not an expected measurement result, and the network entity and method may further be configured to, capable of, performed, performable, or operable to transmit a sensing measurement request to a second sensing entity, wherein the first sensing entity is a first TRP of a base station and the second sensing entity is a second TRP of the base station.

In some implementations of the network entity and method described herein, to determine whether the sensing measurement result is an expected measurement result, the network entity and method may further be configured to, capable of, performed, performable, or operable to identify a mismatch between one or more parameters of the sensing measurement result and one or more parameters of the expected measurement result, including a parameter for movement of a target object associated with the sensing measurement result or a parameter for a radar cross-section (RCS) of the target object in a sensing area.

### BRIEF DESCRIPTION OF THE DRAWINGS

FIG. 1 illustrates an example of a wireless communications system in accordance with aspects of the present disclosure.

FIG. 2 illustrates an example of a sensing scenario in accordance with aspects of the present disclosure.

FIGS. 3-4 illustrate example messaging flows for performing sensing operations in accordance with aspects of the present disclosure.

FIG. 5 illustrates an example of a sensing measurement verification procedure in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by an NE in accordance with aspects of the present disclosure.

FIG. 10 illustrates a flowchart of a method performed by an NE in accordance with aspects of the present disclosure.

### DETAILED DESCRIPTION

The wireless communications system, via the various communication devices, can perform radio sensing to improve network performance and/or serve various use cases or associated services. Radio sensing operates to obtain environment information by using radio-frequency (RF) signaling to detect objects or areas within an environment, such as a physical location or environment that includes a UE or other user devices.

A radio sensing mechanism, scheme, or technique (e.g. via integrated sensing and communication (ISAC)) can include: transmission of a sensing excitation signal (e.g., a sensing reference signal (RS)) from a sensing entity (e.g., a network entity or UE), reception of reflections/echoes of the transmitted sensing excitation signal from the environment by the sensing entity (e.g., a network entity or UE), and/or processing of the received reflections to infer information from the environment or objects within the environment.

For example, ISAC may introduce monostatic sensing modes for network entities (e.g., base stations and/or TRPs of base stations), such as when sensing or otherwise detecting unmanned (uncrewed) aerial vehicles (UAVs) or other moving target objects within a target area or location. A dedicated network function, such as a sensing function, may operate to manage or control sensing operations.

Various security procedures or mechanisms may be utilized to protect communications during sensing operations (e.g., between a sensing entity and a sensing function). For example, the wireless communications system may employ integrity protection, confidentiality protection, and/or replay protection to protect from the tampering of messages transmitted during the sensing operations.

The security mechanisms, however, may not be suitable for protecting the sensing operations from other attacks or nefarious actors. For example, the sensing entity (e.g., in a monostatic sensing mode) may capture sensing measurements from objects other than a targeted object, such as objects placed or moved into an area to hide or obfuscate the targeted object from detection, among other problems.

Various aspects of the present disclosure introduce sensing operations and associated sensing procedures that avoid or mitigate issues associated with the incorrect detection of an object, such as an erroneous detection of a targeted object due to obstacles within a target sensing area. For example, a sensing function may be configured to perform checks or verifications on received sensing measurement results (e.g., sanity checks) and adjust running sensing operations based on the performed checks or verifications.

The sensing function may determine whether a sensing measurement result is an expected measurement result (e.g., includes parameters expected within various measurements), and perform actions based on whether the sensing measurement results matches the expected measurement results. For example, when the target object is a UAV, the sensing function may determine that a sensing measurement result associated with the UAV is an expected measurement result when the sensing measurement result includes a parameter that indicates the sensed target object is moving and/or at a certain location (e.g., at a height above a certain threshold height) within a sensing target area.

Thus, the sensing function, acting as a verification mechanism, may avoid the unintended or incorrect detection of target objects (e.g., due to obstacles within a sensing area), among other benefits. The sensing function, therefore, may provide requesting entities with verified and accurate sensing results, increasing the fidelity and confidence associated with utilizing sensing to detect, track, and/or identify objects, among other benefits.

Aspects of the present disclosure are described in the context of a wireless communications system.

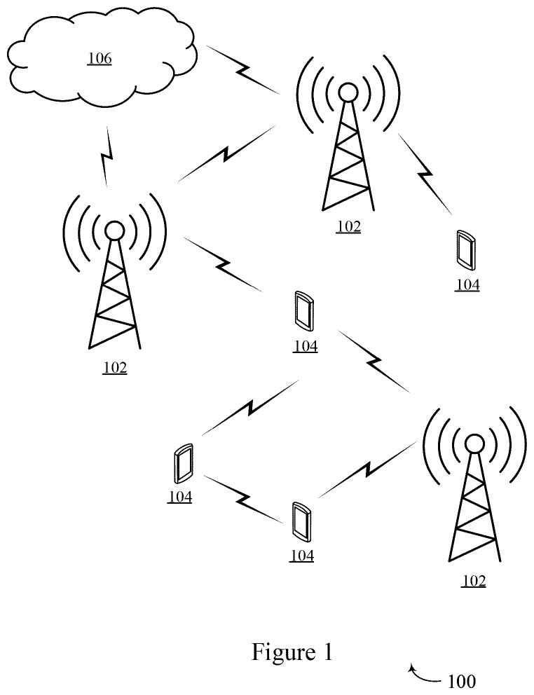

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20, and ISO18000-6C UHF RFID. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), a reader device (e.g., AIoT reader, an RFID reader), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an AIoT device, an RFID tag, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

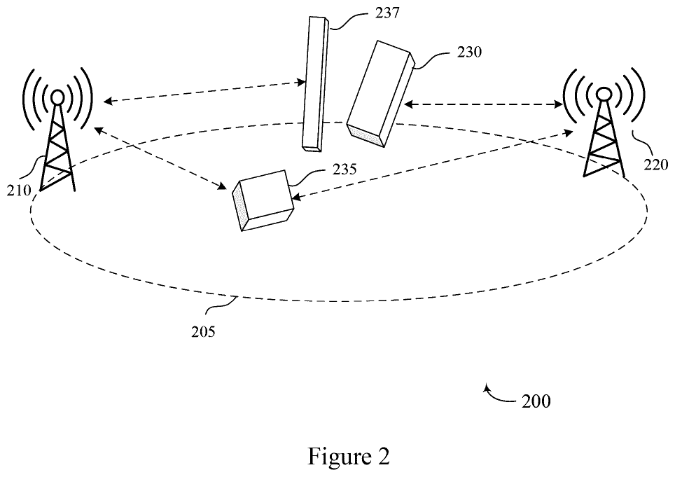

The wireless communications system 100 may support the implementation of ISAC, such as the sensing, tracking, or detection of target objects within a target sensing area (e.g., an identified geographical location), such as UAVs or other objects that travel through the area. FIG. 2 illustrates an example of a sensing scenario 200 in accordance with aspects of the present disclosure.

A sensing entity 210 (e.g., a gNB) receives a request from a sensing function to perform a sensing operation (e.g., one or more sensing tasks) associated with a target object 230 within a sensing area 205. However, there is an obstacle 237 (e.g., another object or structure) that is temporarily or permanently placed between the sensing entity 210 and the target object 230. The sensing entity 210 performs a sensing operation to obtain sensing measurements for the target object 230, but instead obtains sensing measurements for the obstacle 237.

The sensing function, upon receiving the sensing measurements from the sensing entity, determines that the sensing measurements include unexpected information or parameters, such as information that indicates movement of the object and/or a certain location within which the object was sensed (e.g., possibly indicating a replay attack at the sensing function).

Based on the unexpected information, the sensing function identifies and/or instructs a different sensing entity, such as sensing entity 220 (e.g., another gNB associated with the sensing area 205) to sense the target object 230. The sensing entity 220 performs a sensing operation (e.g., a sensing operation that has been modified and/or adjusted) to obtain additional sensing measurements for the target object 230 (e.g., does not encounter the obstacle 237). In some cases, the sensing entity 210 and the sensing entity 220 are both TRPs of a single gNB.

Using the additional sensing measurements, the sensing function verifies, confirms, and/or disregards the accuracy of the initial sensing measurements. The sensing function, based on a comparison and/or verification of the obtained sensing measurements, may provide accurate sensing measurement results to a requesting entity, such as a sensing service customer.

The sensing function may also use both sensing entities 210, 220 (e.g., two or more gNBs) to obtain sensing measurements for a target object 235. For example, neither sensing entity 210, 220 encounters the obstacle 237 when measuring the target object 235. The sensing function, therefore, may use the information obtained from one or both of the sensing entities 210, 220 as a sensing information result to be provided to a sensing service customer.

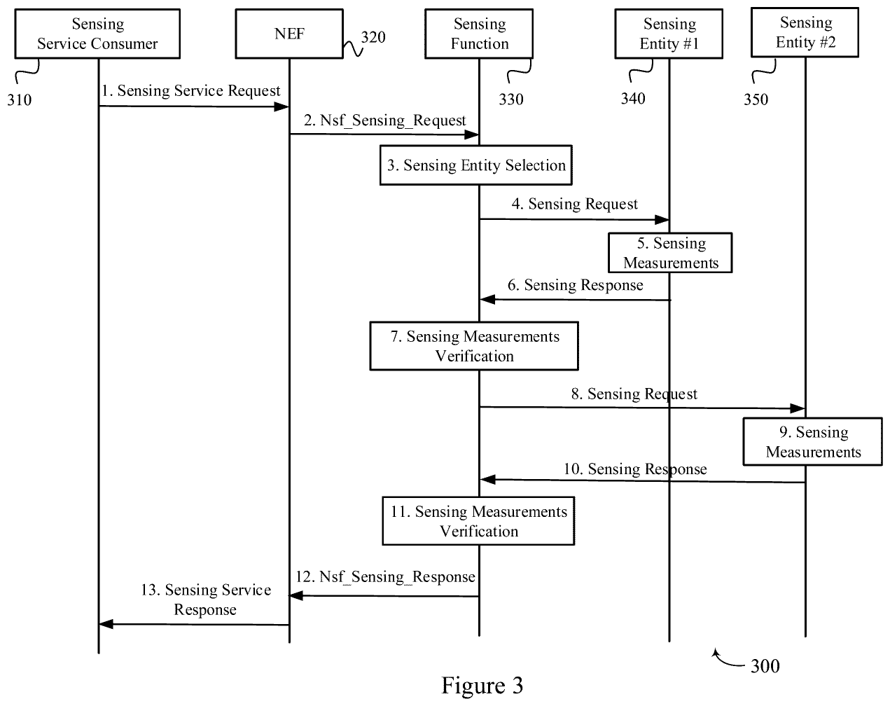

FIG. 3 illustrates an example messaging flow 300 for performing sensing operations in accordance with aspects of the present disclosure. The messaging flow 300 may include a sensing service consumer 310, a network exposure function (NEF) 320, a sensing function 330, a sensing entity 340 (e.g., sensing entity #1), and a sensing entity 350 (e.g., sensing entity #2), which may be examples of sensing service consumers, NEFs, sensing functions, and sensing entities, as described herein. In the following description of the messaging flow 300, the operations between the sensing service consumer 310, the NEF 320, the sensing function 330, the sensing entity 340, and the sensing entity 350 may be performed in different orders or at different times. Some operations may also be omitted, or other operations may be added. Although the sensing service consumer 310, the NEF 320, the sensing function 330, the sensing entity 340, and the sensing entity 350 are shown performing the operations of the messaging flow 300, some aspects of some operations may also be performed by other entities of the messaging flow 300 or by entities that are not shown in the messaging flow 300, or any combination thereof.

In some cases, the sensing service consumer 310 is an entity that may consume and/or request a sensing result. The sensing service consumer 310 may be an internal or external application function (AF) and/or a sensing service client that is external (e.g., residing outside a 3GPP network) or internal (residing within a device, such as a UE). In some cases, the sensing service consumer 310 has established a security association with the NEF 320.

In some cases, the sensing function 330 may be a logical function that supports a sensing service (e.g., a service that performs sensing operations). The sensing function may include a sensing control function (SCF), a sensing processing function (SPF), and/or a sensing gateway (SG), and may be a physical CN function capable of supporting tasks related to sensing (e.g., configuration, receiving measurement reports, performing sensing result calculations, and so on).

In some cases, the sensing entity 340 and/or the sensing entity 350 may be a gNB or other base station, a transmitting node, a sensing transmitter, a receiving node, a sensing receiver, and so on.

At step 1, the sensing service consumer 310 sends a sensing service request to the NEF 320. For example, the sensing service consumer 310 sends a sensing service request that includes a sensing service type (e.g., object detection, object tracking, environment sensing, and so on), sensing service requirements or a sensing QoS (e.g., accuracy, latency, resolution, and so on), a frequency of receiving sensing results (e.g., one shot, periodic or event-based subscription, and/or time information when the sensing service is to be performed (e.g., a time for sensing measurement and/or reporting). The sensing service request may include a target sensing service area (the sensing area 205) and/or a target UE (e.g., the target object 230).

In some cases, the target sensing area and/or target UE may be defined and/or identified with a new sensing area (SA) identifier, where a SA ID may include or be an existing ID, such as a type allocation code (TAC), a RAN Area ID, a TRP ID, a physical cell identity (PCI), an absolute radio frequency channel number (ARFCN), an NR cell global identifier (NCGI), and/or UE IDs (e.g., a temporary mobile subscriber identity (TMSI), an international mobile equipment identity (IMEI), and so on).

At step 2, the NEF 320 sends an Nsf_sensing_Request message to the sensing function 330. For example, the NEF 320 selects a sensing function to invoke a requested sensing service and/or to authorize a sensing service request. The Nsf_sensing_Request message may include an AF ID and the sensing information received from the sensing service consumer 310.

At step 3, the sensing function 330 selects a sensing entity. For example, the sensing function 330 selects the sensing entity 340 based on information in the sensing request, such as target sensing area or location.

At step 4, the sensing function 330 sends a sensing request to the sensing entity 340. For example, the sensing function 330 sends information associated with a sensing operation to be performed for the sensing service consumer 310. In some cases, the sensing request includes an indication or request to provide a TRP configuration back to the sensing function 330, such as information identifying support of two or more TRPs.

At step 5, the sensing entity 340 obtains sensing measurements. For example, the sensing entity 340 performs a sensing operation based on information/instructions within the sensing request.

At step 6, the sensing entity 340 sends a sensing response to the sensing function 330. For example, the sensing entity 340 transmits a sensing measurement result or results to the sensing function 330. In some cases, the sensing response includes TRP capability and/or configuration information for the sensing entity 340. In some cases, the sensing entity may transmit the TRP information upon receiving a request from the sensing function 330. For example, the sensing function 330 may identify one or more candidate TRPs located the sensing service area or that provide coverage for a target sensing service area and request information for the candidate TRPs.

At step 7, the sensing function 330 verifies the sensing measurements. For example, the sensing function 330 performs a check or verification (e.g., a sanity check) by matching the measurement results to expected measurement results for the sensing operation.

In some cases, such as when the target object is expected to be moving, the sensing function 330 verifies the measurement results when the measurement results include information or parameters that indicates the target object is moving. However, when the measurement results include information or parameters that indicates the target object is not moving, the sensing function 330 may not verify the sensing measurements, and perform an action based on the determination.

In some cases, the sensing function 330 may detect that a radar cross-section (RCS) of the target object does not match a pre-defined/expected RCS of the target object in a sensing location/area (e.g., possibly due to a temporary obstacle with a similar/different RCS with respect to the RCS that is received at multiple time instances indicating a possible replay attack). The RCS may be based on the sensing measurements.

Thus, the sensing function 330 may determine whether the sensing measurement result is an expected measurement result by identifying a mismatch between one or more parameters of a sensing measurement result and one or more parameters of an expected measurement result, where the parameters include movement (or lack of movement) of a target object, a size or location of the target object, an RCS of the target object, and/or other parameters.

Based on a negative result of the verification, the sensing function 330 may determine to obtain measurement results with sensing measurements from a different sensing location and select the sensing entity 350 to perform additional sensing measurements of a target object. In some cases, the sensing function 330 may limit, modify, and/or adjust a sensing request to only repeat measurements to be verified.

At step 8, the sensing function 330 sends a new or additional sensing request to the sensing entity 350. For example, the new/additional sensing request may be an adjusted or modified request that includes a request for a subset of the measurement results (e.g., results, measurements, or parameters to be verified).

At step 9, the sensing entity 350 obtains sensing measurements. For example, the sensing entity 350 performs a sensing operation based on information/instructions within the new or additional sensing request.

At step 10, the sensing entity 350 sends a sensing response to the sensing function 330. For example, the sensing entity 350 transmits a sensing measurement result or results to the sensing function 330.

At step 11, the sensing function 330 verifies the sensing measurements. For example, the sensing function 330 verifies the sensing measurements received from the sensing entity 340 with the sensing measurements received from the sensing entity 350. The sensing function 330, therefore, may determine whether a sensing measurement result received from a first sensing entity is an expected measurement result, obtain at least one additional sensing measurement result from one or more additional sensing entities, and generate a sensing information result based on the various sensing measurement results (as described herein).

At step 12, the sensing function 330 transmits an Nsf_Sensing_Response message to the NEF 320. For example, the Nsf_Sensing_Response message includes the sensing information result and any indicators associated with the sensing measurements (e.g., indicators for any ambiguous or unverified information or parameters).

At step 13, the NEF 320 sends a sensing service response message to the sensing service consumer 310. For example, the NEF 320 sends the sensing information result to the sensing service consumer 310 that requested the sensing service and/or sensing operations.

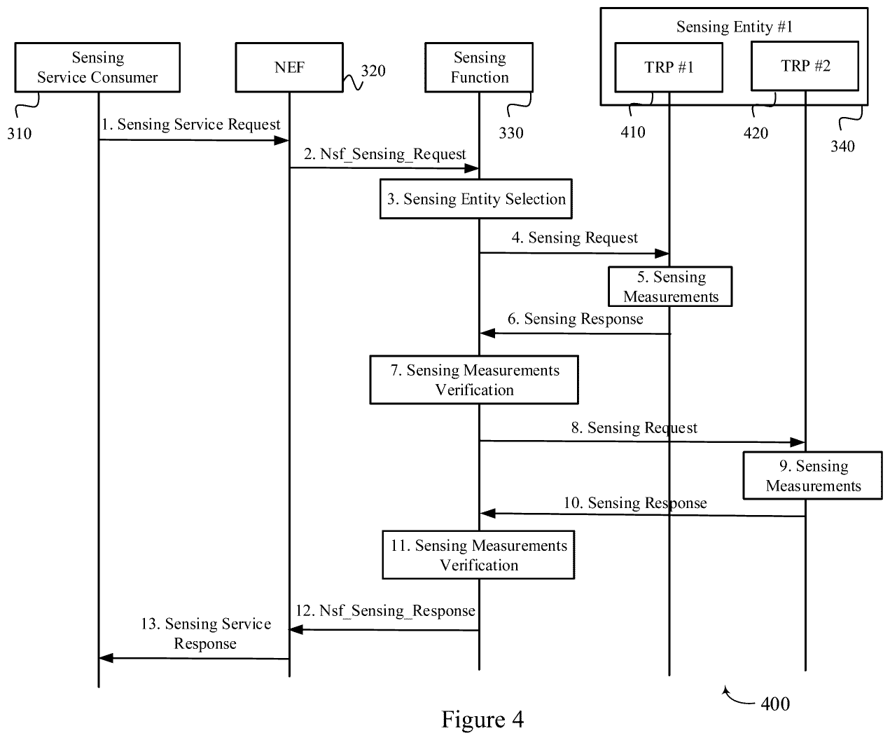

In some examples, the sensing function 330 may utilize sensing measurement results from multiple TRPs (e.g., associated with a single gNB) when verifying sensing measurements during sensing operations for a target object. FIG. 4 illustrates an example messaging flow 400 for performing sensing operations in accordance with aspects of the present disclosure.

The messaging flow 400 may include the sensing service consumer 310, the NEF 320, the sensing function 330, and the sensing entity 340, including a TRP 410 (e.g., a TRP #1) and a TRP 420 (e.g., a TRP #2), which may be examples of sensing service consumers, NEFs, sensing functions, sensing entities, and TRPs, as described herein. In the following description of the messaging flow 400, the operations between the sensing service consumer 310, the NEF 320, the sensing function 330, the sensing entity 340, the TRP 410, and the TRP 420 may be performed in different orders or at different times. Some operations may also be omitted, or other operations may be added. Although the sensing service consumer 310, the NEF 320, the sensing function 330, the sensing entity 340, the TRP 410, and the TRP 420 are shown performing the operations of the messaging flow 3400, some aspects of some operations may also be performed by other entities of the messaging flow 400 or by entities that are not shown in the messaging flow 400, or any combination thereof.

At step 1, the sensing service consumer 310 sends a sensing service request to the NEF 320. For example, the sensing service consumer 310 sends a sensing service request that includes a sensing service type (e.g., object detection, object tracking, environment sensing, and so on), sensing service requirements or a sensing QoS (e.g., accuracy, latency, resolution, and so on), a frequency of receiving sensing results (e.g., one shot, periodic or event-based subscription, and/or time information when the sensing service is to be performed (e.g., a time for sensing measurement and/or reporting). The sensing service request may include a target sensing service area (the sensing area 205) and/or a target UE (e.g., the target object 230).

In some cases, the target sensing area and/or target UE may be defined and/or identified with a new sensing area (SA) identifier, where a SA ID may include or be an existing ID, such as a type allocation code (TAC), a RAN Area ID, a TRP ID, a physical cell identity (PCI), an absolute radio frequency channel number (ARFCN), an NR cell global identifier (NCGI), and/or UE IDs (e.g., a temporary mobile subscriber identity (TMSI), an international mobile equipment identity (IMEI), and so on).

At step 2, the NEF 320 sends an Nsf_sensing_Request message to the sensing function 330. For example, the NEF 320 selects a sensing function to invoke a requested sensing service and/or to authorize a sensing service request. The Nsf_sensing_Request message may include an AF ID and the sensing information received from the sensing service consumer 310.

At step 3, the sensing function 330 selects a sensing entity. For example, the sensing function 330 selects the sensing entity 340 based on information in the sensing request, such as target sensing area or location.

At step 4, the sensing function 330 sends a sensing request to the sensing entity 340. For example, the sensing function 330 sends information associated with a sensing operation to be performed for the sensing service consumer 310. In some cases, the sensing request includes an indication or request to provide a TRP configuration back to the sensing function 330, such as information identifying support of two or more TRPs.

At step 5, the sensing entity 340 obtains sensing measurements. For example, the sensing entity 340 performs a sensing operation based on information/instructions within the sensing request. To perform or obtain the sensing measurements, the sensing entity 340 selects a suitable TRP (e.g., the TRP 410) to obtain the sensing measurements.

At step 6, the sensing entity 340 sends a sensing response to the sensing function 330. For example, the sensing entity 340 transmits a sensing measurement result or results to the sensing function 330. In some cases, the sensing response includes TRP capability and/or configuration information for the sensing entity 340. For example, the sensing response may include whether other TRPs (e.g., the TRP 420) support or service a target sensing area. The sensing response may identify candidate, available, and/or suitable TRPs by TRP identifiers, including PCIs, ARFCNs, NCGIs, and so on.

At step 7, the sensing function 330 verifies the sensing measurements. For example, the sensing function 330, as described herein, performs a check or verification by matching the measurement results to expected measurement results for the sensing operation. Based on a negative result of the verification, the sensing function 330 may determine to obtain measurement results with sensing measurements from a different sensing location and select the TRP 420 to perform additional sensing measurements of a target object. In some cases, the sensing function 330 may limit, modify, and/or adjust a sensing request to only repeat measurements to be verified.

At step 8, the sensing function 330 sends a new or additional sensing request to the TRP 420 (via the sensing entity 340). For example, the new/additional sensing request may be an adjusted or modified request that includes a request for a subset of the measurement results (e.g., results, measurements, or parameters to be verified).

At step 9, the sensing entity 340, using the TRP 420, obtains sensing measurements. For example, the TRP 420 performs a sensing operation based on information/instructions within the new or additional sensing request.

At step 10, the sensing entity 350 sends a sensing response to the sensing function 330. For example, the sensing entity 350 transmits a sensing measurement result or results to the sensing function 330.

At step 11, the sensing function 330 verifies the sensing measurements. For example, the sensing function 330 verifies the sensing measurements obtained by the TRP 410 with the sensing measurements obtained by the TRP 420. The sensing function 330, therefore, may determine whether a sensing measurement result received from a first sensing entity is an expected measurement result, obtain at least one additional sensing measurement result from one or more additional sensing entities, and generate a sensing information result based on the various sensing measurement results (as described herein).

At step 12, the sensing function 330 transmits an Nsf_Sensing_Response message to the NEF 320. For example, the Nsf_Sensing_Response message includes the sensing information result and any indicators associated with the sensing measurements (e.g., indicators for any ambiguous or unverified information or parameters).

At step 13, the NEF 320 sends a sensing service response message to the sensing service consumer 310. For example, the NEF 320 sends the sensing information result to the sensing service consumer 310 that requested the sensing service and/or sensing operations.

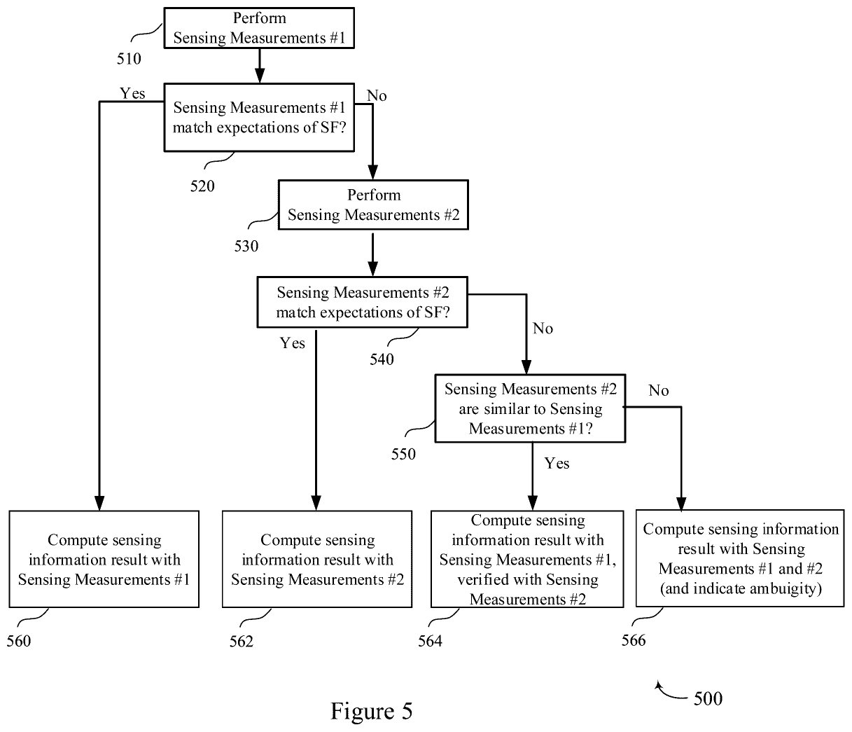

As described herein, the sensing function 330, in some examples, may perform actions in response to determining whether a sensing measurement result is an expected measurement result. FIG. 5 illustrates an example of a sensing measurement verification procedure 500 in accordance with aspects of the present disclosure.

At step 510, the sensing function 330 performs (or causes to perform) a first set of sensing measurements (e.g., sensing measurements #1). Upon receiving the sensing measurements, the sensing function 330, at step 520, determines whether the sensing measurements meet or match expected results (e.g., include expected parameters).

When the sensing measurements (e.g., sensing measurements #1) meet or match the expected results, the sensing function 330, at step 560, computes or otherwise determines a sensing information result with the sensing measurements #1. However, when the sensing measurements do not meet or match the expected results, the sensing function 330, at step 530, performs (or causes to perform) a second set of sensing measurements (e.g., sensing measurements #2).

At step 540, the sensing function 330 determines whether the sensing measurements meet or match expected results (e.g., include expected parameters). When the sensing measurements (e.g., sensing measurements #2) meet or match the expected results, the sensing function 330, at step 562, computes or otherwise determines a sensing information result with the sensing measurements #2.

However, when the sensing measurements do not meet or match the expected results, the sensing function 330, at step 550, determines whether the sensing measurements (e.g., sensing measurements #1 and sensing measurements #2) are similar (e.g., include similar or matching parameters). When the sensing measurements match or are similar, the sensing function 330, at step 564, computes or otherwise determines a sensing information result with the sensing measurements #1 and the sensing measurements #2 (e.g., verifying a first set of measurements with a second set of measurements).

However, when the sensing measurements do not match or are not similar, the sensing function 330, at step 566, computes or otherwise determines a sensing information result with the sensing measurements #1 and the sensing measurements #2 and indicates an ambiguity in the result. For example, the sensing information result may include an indication of a mismatch of parameters, such as a result accuracy indication of the discrepancy of the two sensing measurements from the expected measurement result (e.g., indicated as a percentage or delta from the expected measurement result).

Thus, the sensing function 330 may be configured to perform different actions for generating a sensing information result based on one or multiple sets of sensing measurement results and/or based on matches of parameters within each of the sets of the sensing measurement results.

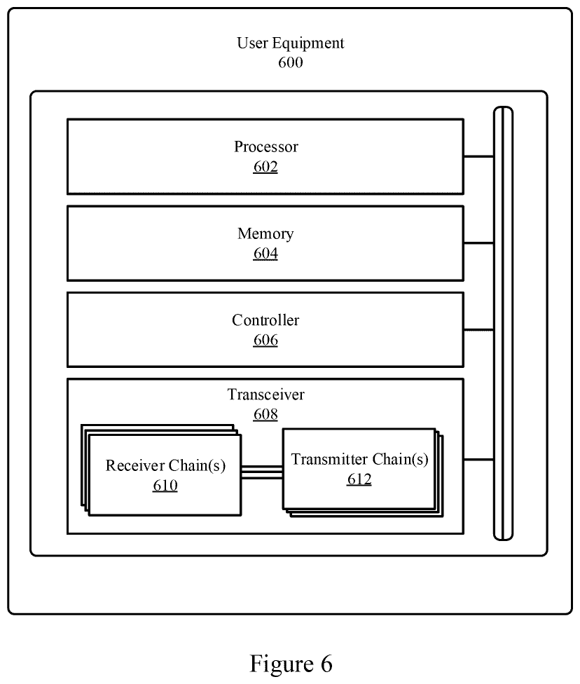

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

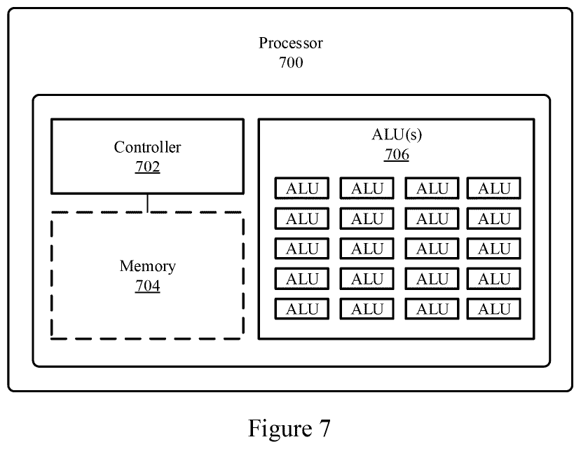

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein.

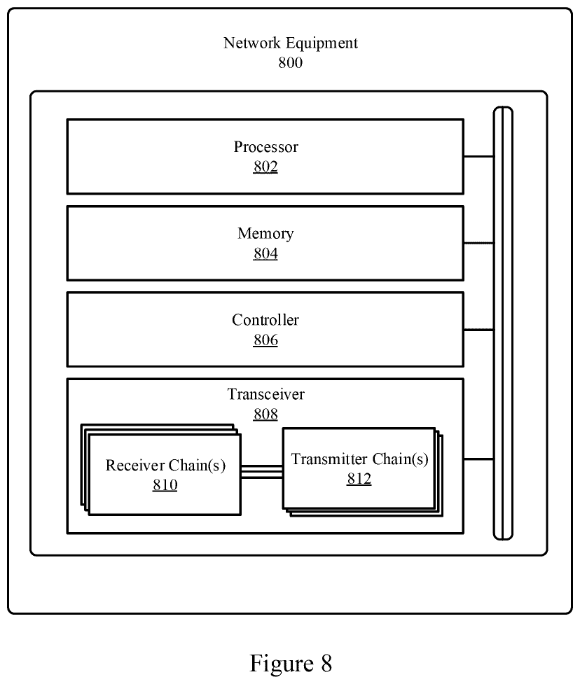

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 (e.g., as a sensing function) may be configured to support a means for transmitting a sensing measurement request to a sensing entity, receiving, in response to the sensing measurement request, a sensing measurement result from the sensing entity, determining whether the sensing measurement result comprises an expected measurement result; and performing an action based on the determination.

As another example, the NE 800 (e.g., as a sensing function) may be configured to support a means for receiving a sensing measurement result from a first sensing entity, determining whether the sensing measurement result comprises an expected measurement result; and generating a sensing information result based on the determination.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

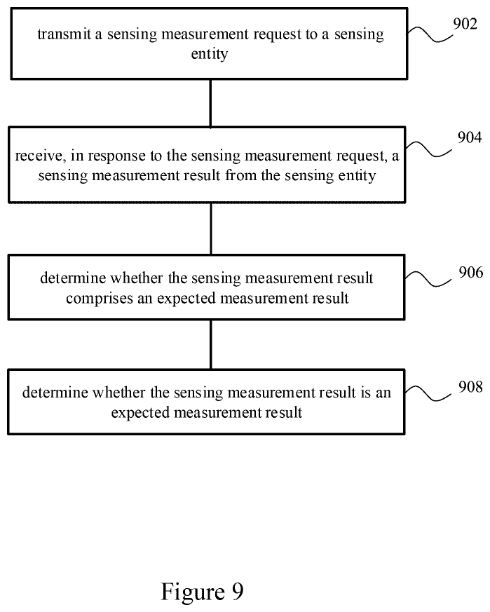

FIG. 9 illustrates a flowchart of a method in accordance with aspects of the present disclosure. The operations of the method may be implemented by an NE (e.g., as a sensing function) as described herein. In some implementations, the NE may execute a set of instructions to control the function elements of the NE to perform the described functions.

At 902, the method may include transmitting a sensing measurement request to a sensing entity. The operations of 902 may be performed in accordance with examples as described herein. In some implementations, aspects of the operations of 902 may be performed by an NE as described with reference to FIG. 8.

At 904, the method may include receiving, in response to the sensing measurement request, a sensing measurement result from the sensing entity. The operations of 904 may be performed in accordance with examples as described herein. In some implementations, aspects of the operations of 904 may be performed by an NE as described with reference to FIG. 8.

At 906, the method may include determining whether the sensing measurement result comprises an expected measurement result. The operations of 906 may be performed in accordance with examples as described herein. In some implementations, aspects of the operations of 906 may be performed by an NE as described with reference to FIG. 8.

At 908, the method may include performing an action based on the determination. The operations of 908 may be performed in accordance with examples as described herein. In some implementations, aspects of the operations of 908 may be performed by an NE as described with reference to FIG. 8.

It should be noted that the method described herein describes a possible implementation, and that the operations and the steps may be rearranged or otherwise modified and that other implementations are possible.

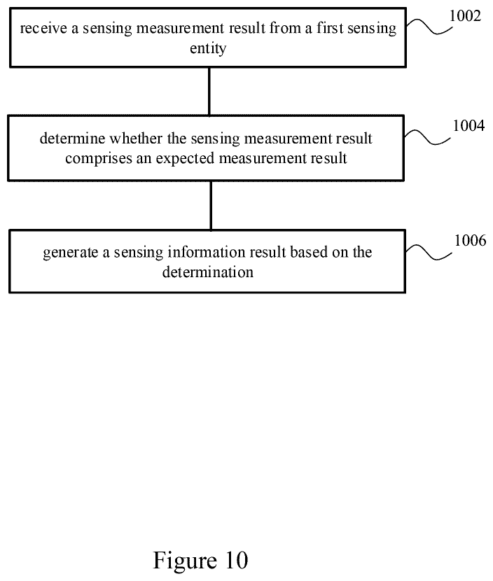

FIG. 10 illustrates a flowchart of a method in accordance with aspects of the present disclosure. The operations of the method may be implemented by an NE (e.g., as a sensing function) as described herein. In some implementations, the NE may execute a set of instructions to control the function elements of the reader device to perform the described functions.

At 1002, the method may include receiving a sensing measurement result from a first sensing entity. The operations of 1002 may be performed in accordance with examples as described herein. In some implementations, aspects of the operations of 1002 may be performed by an NE as described with reference to FIG. 8.

At 1004, the method may include determining whether the sensing measurement result comprises an expected measurement result. The operations of 1004 may be performed in accordance with examples as described herein. In some implementations, aspects of the operations of 1004 may be performed by an NE as described with reference to FIG. 8.

At 1006, the method may include and generating a sensing information result based on the determination. The operations of 1006 may be performed in accordance with examples as described herein. In some implementations, aspects of the operations of 1006 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
transmit a sensing measurement request to a sensing entity;
receive, in response to the sensing measurement request, a sensing measurement result from the sensing entity;
determine whether the sensing measurement result comprises an expected measurement result; and
perform an action based on the determination.

2. The network entity of claim 1, wherein, to determine whether the sensing measurement result comprises an expected measurement result, the at least one processor is configured to cause the network entity to:
identify a mismatch between one or more parameters of the sensing measurement result and one or more parameters of the expected measurement result.

3. The network entity of claim 2, wherein the one or more parameters of the sensing measurement result and the expected measurement result include at least one parameter for movement of a target object associated with the sensing measurement result.

4. The network entity of claim 2, wherein the one or more parameters of the sensing measurement result and the expected measurement result include at least one parameter for a size or location of a target object associated with the sensing measurement result.

5. The network entity of claim 1, wherein the sensing measurement result is an unexpected measurement result, and wherein the at least one processor is configured to cause the network entity to perform the action by:
adjusting one or more parameters of a subsequent sensing measurement request; and
transmitting the subsequent sensing measurement request to a different sensing entity.

6. The network entity of claim 5, wherein the adjusted one or more parameters include an identification of a sensing area within which to perform a sensing measurement.

7. The network entity of claim 5, wherein the adjusted one or more parameters are associated with a subset of measurements that caused the unexpected measurement result.

8. The network entity of claim 1, wherein the sensing measurement result is an unexpected measurement result, and wherein the at least one processor is configured to cause the network entity to perform the action by:
adjusting one or more parameters of a subsequent sensing measurement request; and
transmitting the subsequent sensing measurement request to a transmission and reception point (TRP) of the sensing entity that is different than an initial TRP that performed a sensing measurement indicated in the sensing measurement result.

9. The network entity of claim 8, wherein the sensing measurement result includes an identification of the initial TRP that performed the sensing measurement.

10. The network entity of claim 1, wherein the at least one processor is further configured to cause the network entity to:
receive, from a network function, a sensing request having one or more parameters, including: an identifier of a target sensing area, an identifier of a target object, or a sensing service type for a sensing measurement; and
select the sensing entity based on the one or more parameters of the sensing request.

11. The network entity of claim 10, wherein the sensing measurement result is an unexpected measurement result, and wherein the at least one processor is configured to cause the network entity to perform the action by:
transmitting a subsequent sensing measurement request;
receiving a subsequent sensing measurement result;
comparing the subsequent sensing measurement result with the sensing measurement result and the expected measurement result; and
determining a sensing information result based on the comparison.

12. The network entity of claim 11, wherein the at least one processor is further configured to cause the network entity to:
transmit, to the network function, a sensing response message that includes the sensing information result.

13. A network entity for wireless communication, comprising:
at least one memory; and
at least one processor coupled with the at least one memory and configured to cause the network entity to:
receive a sensing measurement result from a first sensing entity;
determine whether the sensing measurement result comprises an expected measurement result; and
generate a sensing information result based on the determination.

14. The network entity of claim 13, wherein the sensing measurement result is not an expected measurement result, and wherein the at least one processor is configured to cause the network entity to generate the sensing information result by:
transmitting a sensing measurement request to a second sensing entity;
receiving a subsequent sensing measurement result from the second sensing entity;
comparing the subsequent sensing measurement result with the expected measurement result; and
when the subsequent sensing measurement result matches the expected measurement result, generating the sensing information result using the subsequent sensing measurement result.

15. The network entity of claim 13, wherein the sensing measurement result is not an expected measurement result, and wherein the at least one processor is configured to cause the network entity to generate the sensing information result by:
transmitting a sensing measurement request to a second sensing entity;
receiving a subsequent sensing measurement result from the second sensing entity;
comparing the subsequent sensing measurement result with the expected measurement result; and
when the subsequent sensing measurement result does not match the expected measurement result, generating the sensing information result using the sensing information result and subsequent sensing measurement result.

16. The network entity of claim 13, wherein the sensing measurement result is not an expected measurement result, and wherein the at least one processor is configured to cause the network entity to generate the sensing information result by:
transmitting a sensing measurement request to a second sensing entity,
wherein the first sensing entity is a first base station and the second sensing entity is a second base station different from the first base station.

17. The network entity of claim 13, wherein the sensing measurement result is not an expected measurement result, and wherein the at least one processor is configured to cause the network entity to generate the sensing information result by:
transmitting a sensing measurement request to a second sensing entity,
wherein the first sensing entity is a first transmission and reception point (TRP) of a base station and the second sensing entity is a second TRP of the base station.

18. The network entity of claim 1, wherein, to determine whether the sensing measurement result is an expected measurement result, the at least one processor is configured to cause the network entity to:
identify a mismatch between one or more parameters of the sensing measurement result and one or more parameters of the expected measurement result, including:
a parameter for movement of a target object associated with the sensing measurement result, or
a parameter for a radar cross-section (RCS) of the target object in a sensing area.

19. A method performed by a network entity, the method comprising:
transmitting a sensing measurement request to a sensing entity;
receiving, in response to the sensing measurement request, a sensing measurement result from the sensing entity;
determining whether the sensing measurement result comprises an expected measurement result; and
performing an action based on the determination.

20. A method performed by a network entity, the method comprising:
receiving a sensing measurement result from a first sensing entity;
determining whether the sensing measurement result comprises an expected measurement result; and
generating a sensing information result based on the determination.
